(19) United States
(12) Patent Application Publication
(10) Pub. No.: US 2016/0227567 A1
(43) Pub. Date: Aug. 4, 2016

(54) PBCH TRANSMISSION METHOD, SYSTEM, AND DEVICE

(71) Applicant: CHINA ACADEMY OF TELECOMMUNICATIONS TECHNOLOGY, Beijing (CN)

(72) Inventors: Weijie Xu, Beijing (CN); Xueming Pan, Beijing (CN); Zukang Shen, Beijing (CN); Yanping Xing, Beijing (CN); Minli Jia, Beijing (CN)

(73) Assignee: China Academy of Telecommunications Technology, Beijing (CN)

(21) Appl. No.: 15/025,281

(22) PCT Filed: Sep. 26, 2014
(86) PCT No.: PCT/CN2014/087510

§ 371 Date: Mar. 28, 2016

(30) Foreign Application Priority Data
Sep. 27, 2013 (CN) 201310452085.2

(51) Int. Cl. H04W 72/12; H04W 72/00

(52) U.S. Cl. CPC H04W 72/1273; H04W 72/005

(57) ABSTRACT

The present application relates to the technical field of wireless communications, and in particular, to a PBCH transmission method, system, and device, which are used to transmit an enhanced PBCH. The method of the present application comprises: a network side device determining a resource of a coverage-enhanced PBCH mapped in at least one radio frame; and the network side device transmitting the coverage-enhanced PBCH on the determined resource. In the present application, a network side device determines a resource of a coverage-enhanced PBCH mapped in at least one radio frame, and transmits the coverage-enhanced PBCH on the determined resource. Because a resource that bears a coverage-enhanced PBCH can be determined, thereby implementing transmission of the coverage-enhanced PBCH and improving system performance.

This application claims the benefit of Chinese Patent Application No. 201310452085.2, filed with the State Intellectual Property Office of People's Republic of China on Sep. 27, 2013 and entitled “PBCH Transmission Method, System, and Device”, the content of which is hereby incorporated by reference in its entirety.

### FIELD

The present invention relates to the field of wireless communications and particularly to a method, system, and device for transmitting a PBCH.

### BACKGROUND

The Machine Type Communication (MTC) function needs to be supported in the third-generation mobile communication system, and the Long Term Evolution (LTE). An MTC device (MTC terminal) can have a part of a number of Machine to Machine (M2M) communication characteristics, e.g., low mobility, a small amount of transmission data, insensitivity to a communication delay, extremely low power consumption as required, etc.

In the existing M2M network based on the Global System for Mobile Communication (GSM), the operators have identified that a wireless signal for a terminal operating in some scenario, e.g., a terminal operating underground, in a shopping mall, or at a corner of a building, may be significantly attenuated because the signal is seriously shielded, so the terminal may fail to communicate with the network, but deep coverage by the network in such a scenario may come with a considerable increase in the cost of deploying the network. The operators have identified from their tests that the coverage demand in the scenario above can be satisfied only if the existing GSM coverage is enhanced by 15 dB. The GSM for M2M transmission will be replaced by later LTE, and since the LTE coverage is substantially comparative to the GSM coverage, the requirement of M2M transmission in the scenario above will also be satisfied by enhancing the LTE coverage by 15 dB.

In order to enhance the coverage by 15 dB, a feasible approach is to retransmit or rate-match the existing channels in the LTE system to lower the coding rate of the channels. A Physical Broadcast Channel (PBCH) may be retransmitted nearly 100 times or more to thereby reach a coverage enhancement of 15 dB.

However there has been absent so far a solution to transmission of a PBCH with enhanced coverage.

### SUMMARY

Embodiments of the invention provide a method, system, and device for transmitting a PBCH so as to transmit the PBCH with enhanced coverage.

An embodiment of the invention provides a method for transmitting a PBCH, the method including:

determining, by a network-side device, resources, in at least one radio frame, to which a PBCH with enhanced coverage is mapped; and

transmitting, by the network-side device, the PBCH with enhanced coverage over the resources determined.

The network-side device according to embodiments of the invention determines resources, in at least one radio frame, to which the PBCH with enhanced coverage is mapped, and transmits the PBCH with enhanced coverage over the resources determined. The resources over which the PBCH with enhanced coverage is carried can be determined to thereby transmit the PBCH with enhanced coverage so as to improve the performance of a system.

Preferably determining, by the network-side device, the resources, in the at least one radio frame, to which the PBCH with enhanced coverage is mapped includes:

determining, by the network-side device, the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs, and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably determining, by the network-side device, the resources, in the at least one radio frame, to which the PBCH with enhanced coverage is mapped includes:

determining, by the network-side device, the following resources in the at least one radio frame as the resources to which the PBCH with enhanced coverage is mapped:

a part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably determining, by the network-side device, the resources, in the at least one radio frame, to which the PBCH with enhanced coverage is mapped includes:

determining, by the network-side device, the following resources in the at least one radio frame as the resources to which the PBCH with enhanced coverage is mapped:

a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably determining, by the network-side device, the resources, in the at least one radio frame, to which the PBCH with enhanced coverage is mapped includes:

determining, by the network-side device, the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

Preferably N is 72.

An embodiment of the invention provides another method for receiving a PBCH, the method including:

determining, by a user equipment, resources, in at least one radio frame, to which the PBCH with enhanced coverage is mapped; and

receiving, by the user equipment, the PBCH with enhanced coverage over the determined resources.

Preferably determining, by the user equipment, the resources, in the at least one radio frame, to which the PBCH with enhanced coverage is mapped includes:

determining, by the user equipment, the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs, and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably determining, by the user equipment, the resources, in the at least one radio frame, to which the PBCH with enhanced coverage is mapped includes:

determining, by the user equipment, the following resources in the at least one radio frame as the resources to which the PBCH with enhanced coverage is mapped:

a part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably determining, by the user equipment, the resources, in the at least one radio frame, to which the PBCH with enhanced coverage is mapped includes:

determining, by the user equipment, the following resources in the at least one radio frame as the resources to which the PBCH with enhanced coverage is mapped:

a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably determining, by the user equipment, the resources, in the at least one radio frame, to which the PBCH with enhanced coverage is mapped includes:

determining, by the user equipment, the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

Preferably N is 72.

An embodiment of the invention provides a network-side device for transmitting a PBCH, the network-side device including:

a first determining module configured to determine, resources, in at least one radio frame, to which a PBCH with enhanced coverage is mapped; and

a transmitting module configured to transmit the PBCH with enhanced coverage over the resources determined.

The network-side device according to embodiments of the invention determines resources, in at least one radio frame, to which the PBCH with enhanced coverage is mapped, and transmits the PBCH with enhanced coverage over the determined resources. The resources over which the PBCH with enhanced coverage is carried can be determined to thereby transmit the PBCH with enhanced coverage so as to improve the performance of a system.

Preferably the first determining module is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs, and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the first determining module is configured:

to determine the following resources in the at least one radio frame as the resources to which the PBCH with enhanced coverage is mapped:

a part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the first determining module is configured:

to determine the following resources in the at least one radio frame as the resources to which the PBCH with enhanced coverage is mapped:

a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the first determining module is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

An embodiment of the invention provides another network-side device for transmitting a PBCH, the network-side device including:

a processor configured to determine, resources, in at least one radio frame, to which a PBCH with enhanced coverage is mapped, and to transmit the PBCH with enhanced coverage over the resources determined through a transceiver; and

the transceiver configured to be controlled by the processor to transmit and receive data.

Preferably the processor is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs, and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the processor is configured:

to determine the following resources in the at least one radio frame as the resources to which the PBCH with enhanced coverage is mapped:

a part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the processor is configured:

to determine the following resources in the at least one radio frame as the resources to which the PBCH with enhanced coverage is mapped:

a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the processor is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

An embodiment of the invention provides a user equipment for receiving a PBCH, the user equipment including:

a second determining module configured to determine resources, in at least one radio frame, to which a PBCH with enhanced coverage is mapped; and

a receiving module configured to receive the PBCH with enhanced coverage over the resources determined.

Preferably the second determining module is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs, and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the second determining module is configured:

to determine the following resources in the at least one radio frame as the resources to which the PBCH with enhanced coverage is mapped:

a part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the second determining module is configured:

to determine the following resources in the at least one radio frame as the resources to which the PBCH with enhanced coverage is mapped:

a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the second determining module is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are d the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

An embodiment of the invention provides another user equipment for receiving a PBCH, the user equipment including:

a processor configured to determine, resources, in at least one radio frame, to which a PBCH with enhanced coverage is mapped, and to receive the PBCH with enhanced coverage over the resources determined through a transceiver; and

the transceiver configured to be controlled by the processor to transmit and receive data.

Preferably the processor is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs, and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the processor is configured:

to determine the following resources in the at least one radio frame as the resources to which the PBCH with enhanced coverage is mapped:

a part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the processor is configured:

to determine the following resources in the at least one radio frame as the resources to which the PBCH with enhanced coverage is mapped:

a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the processor is configured:

to determine the following resources in the at least one radio frame as the resources to which the PBCH with enhanced coverage is mapped:

a part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

a part or all of other REs than REs where CRS ports 0 to 3 are located, in a part or all of other symbols than symbols occupied by PSSs and PDCCHs, in a DwPTS of sub-frame 1; and/or

a part or all of other REs than REs where CRS ports 0 to 3 are located, in specific symbols of sub-frame 6;

wherein the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

An embodiment of the invention provides a system for transmitting a PBCH, the system including:

a network-side device configured to determine resources, in at least one radio frame, to which a PBCH with enhanced coverage is mapped; and to transmit the PBCH with enhanced coverage over the resources determined; and

a user equipment configured to determine the resources, in at least one radio frame, to which the PBCH with enhanced coverage is mapped; and to receive the PBCHs with enhanced coverage over the resources determined.

The network-side device according to embodiments of the invention determines resources, in at least one radio frame, to which the PBCH with enhanced coverage is mapped, and transmits the PBCH with enhanced coverage over the resources determined. The resources over which the PBCH with enhanced coverage is carried can be determined to thereby transmit the PBCH with enhanced coverage so as to improve the performance of a system.

### BRIEF DESCRIPTION OF THE DRAWINGS

FIG. 1 is a schematic structural diagram of a system for transmitting a PBCH according to an embodiment of the invention;

FIG. 2 is a schematic diagram of first resource mapping according to an embodiment of the invention;

FIG. 3 is a schematic diagram of second resource mapping according to an embodiment of the invention;

FIG. 4 is a schematic diagram of third resource mapping according to an embodiment of the invention;

FIG. 5 is a schematic diagram of fourth resource mapping according to an embodiment of the invention;

FIG. 6 is a schematic diagram of fifth resource mapping according to an embodiment of the invention;

FIG. 7 is a schematic diagram of sixth resource mapping according to an embodiment of the invention;

FIG. 8 is a schematic structural diagram of a first network-side device in the system for transmitting a PBCH according to an embodiment of the invention;

FIG. 9 is a schematic structural diagram of a first user equipment in the system for transmitting a PBCH according to an embodiment of the invention;

FIG. 10 is a schematic structural diagram of a second network-side device in the system for transmitting a PBCH according to an embodiment of the invention;

FIG. 11 is a schematic structural diagram of a second user equipment in the system for transmitting a PBCH according to an embodiment of the invention;

FIG. 12 is a schematic flow chart of a method for transmitting a PBCH by a network-side device according to an embodiment of the invention; and

FIG. 13 is a schematic flow chart of a method for receiving a PBCH by a user equipment according to an embodiment of the invention.

### DETAILED DESCRIPTION OF THE EMBODIMENTS

A network-side device according to embodiments of the invention determines resources, in at least one radio frame, to which a PBCH with enhanced coverage is mapped, and transmits the PBCH with enhanced coverage over the resources determined. The resources over which the PBCH with enhanced coverage is carried can be determined to thereby transmit the PBCH with enhanced coverage so as to improve the performance of a system.

The embodiments of the invention will be described below in further details with reference to the drawings.

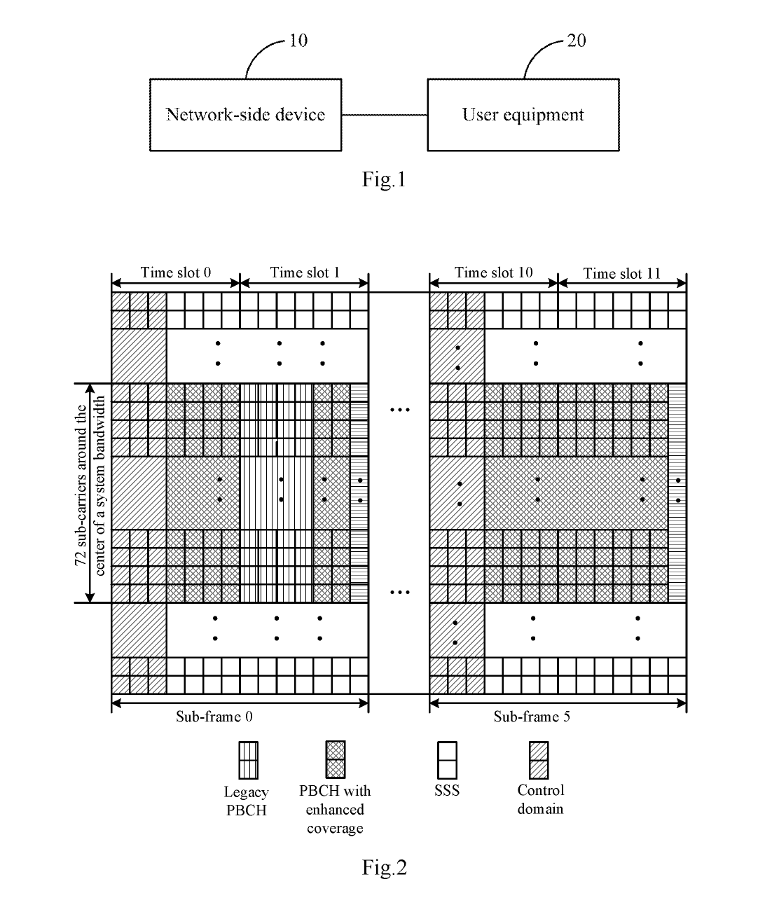

As illustrated in FIG. 1, a system for transmitting a PBCH according to an embodiment of the invention includes:

A network-side device 10 is configured to determine resources, in at least one radio frame, to which a PBCH with enhanced coverage is mapped; and to transmit PBCHs with enhanced coverage over the resources determined.

A user equipment 20 is configured to determine the resources, in at least one radio frame, to which the PBCH with enhanced coverage is mapped; and to receive the PBCH with enhanced coverage over the resources determined.

In an implementation, the particular number of radio frames including the resources to which the PBCH with enhanced coverage is mapped can be specified in a specification, or notified by a higher layer to a base station and the user equipment, or determined by the base station and then notified to the user equipment, as needed.

For example, the number of radio frames including the resources to which the PBCH with enhanced coverage is mapped can be 4, 8, 12, etc. If there are multiple radio frames, then all of these radio frames can be consecutive, or a part of them can be consecutive, or all of them can be inconsecutive.

Preferably the resources, in the at least one radio frame, to which the PBCH with enhanced coverage is mapped, are located on N sub-carriers around the center of the system bandwidth of the radio frame, where N represents a positive integer.

Since there are 72 sub-carriers occupied by the existing PBCH, i.e., the largest number of sub-carriers in the system with a bandwidth of 1.4 MHz, preferably N can be 72 in an implementation. Of course, N can alternatively be another number.

For a radio frame, there may be numerous resources to which the PBCH with enhanced coverage is mapped, and several of them will be listed below.

In a first arrangement, the resources are a part or all of other Resource Elements (REs) than REs where Cell-specific Reference Signal (CRS) ports 0 to 3 are located, in a part or all of other symbols than symbols occupied by legacy PBCH, Secondary Synchronization Signals (SSSs), and Physical Downlink Control Channels (PDCCHs), in a part or all of sub-frame 0, sub-frame 5, and sub-frame 9; and/or

A part or all of other REs than REs where CRS ports 0 to 3 are located, in a part or all of other symbols than symbols occupied by Primary Synchronization Signals (PSSs), and PDCCHs, in a Downlink Pilot Time Slot (DwPTS) of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted in the DwPTS of the sub-frame 1.

In a second arrangement, the resources are a part or all of other REs than REs where reserved Channel State Information-Reference Signals (CSI-RSs) are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

In a third arrangement, the resources are a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

In a fourth arrangement, the resources are a part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

In the first arrangement to the fourth arrangement, the legacy PBCH is the PBCH specified in the 3GPP TS 36.211 Release 8. The PBCH with enhanced coverage according to the embodiment of the invention is PBCH with enhanced coverage relative to the legacy PBCH. The PBCH with enhanced coverage occupies more resources than those occupied by the legacy PBCH. Signal of the PBCH with enhanced coverage is generated by attaching a Cyclic Redundancy Check (CRC) to, convolutional encoding, rate-matching, scrambling, Quaternary Phase Shift Keying (QPSK)-modulation, pre-coding, layer-mapping, etc., source information bits carried in the signals on the PBCHs with enhanced coverage to obtain a sequence of PBCH complex-value signals for enhanced coverage.

In an implementation, those particular sub-frames can be specified in the specification.

For example, if the sub-frame 0 and the sub-frame 5 are specified for transmission, then the network-side device can transmit the PBCH with enhanced coverage in the sub-frame 0 and the sub-frame 5; and the user equipment needs to detect the PBCH with enhanced coverage, in the sub-frame 0 and the sub-frame 5, as specified in the specification. Particularly the user equipment can attempt to detect the PBCH with enhanced coverage according to the particular mapping arrangement of the PBCH resources, respectively based only upon a signal received in the sub-frame 0 or only upon a signal received in the sub-frame 5 or upon the signals received in the sub-frame 0 and the sub-frame 5 as long as resources of the PBCH with enhanced coverage is detected in any one of the three schemes, where if resources to which the PBCH with enhanced coverage is mapped, are detected correctly in the sub-frame 0 alone, then resources to which the PBCH with enhanced coverage is mapped will not be detected in the other sub-frame. If resources to which the PBCH with enhanced coverage is mapped, are not detected correctly in the sub-frame 0 alone, then resources to which the PBCH with enhanced coverage is mapped can be further detected combining with a part of the sub-frame 5 until resources of the PBCH with enhanced coverage are detected correctly.

In another example, if the sub-frame 0, the sub-frame 5, the sub-frame 1, and the sub-frame 6 are specified for transmission, then the network-side device can transmit the PBCHs with enhanced coverage only in the sub-frame 0 and the sub-frame 5, and/or the sub-frame 1 and the sub-frame 6; and particularly if special sub-frames are configured with special sub-frame configuration 0 and the special sub-frame configuration 5, since there are three symbols in the DwPTS, then there will be no additional symbols in which the PBCH with enhanced coverage can be transmitted, so the indices of the symbols in the DwPTS, to which the PBCH with enhanced coverage is mapped, are absent in the special sub-frame with the above special sub-frame configurations (that is, there will be no additional symbols in which the PBCH with enhanced coverage is transmitted), then the network-side device will not transmit the PBCH with enhanced coverage in the DwPTS even if the DwPTS is specified for transmission of the PBCH with enhanced coverage. At this time since the user equipment has no knowledge of the particular configuration of the special sub-frames at the network side, the user equipment will not know whether the PBCH is mapped in the sub-frames 1 and 6, and thus will attempt to detect resources to which the PBCH with enhanced coverage is mapped, assuming that the PBCH with enhanced coverage is transmitted only in the sub-frame 0 and the sub-frame 5, and that the PBCH with enhanced coverage is transmitted in both the sub-frames 0 and 5, and the sub-frames 1 and 6, respectively as long as resources to which the PBCH with enhanced coverage is mapped, are detected with either of the assumptions, where if resources to which the PBCH with enhanced coverage is mapped, are detected correctly in the sub-frame 0 alone, then resources to which the PBCH with enhanced coverage is mapped will not be detected correctly in the other sub-frame. If resources to which the PBCH with enhanced coverage is mapped, are not detected correctly in the sub-frame 0 alone, then resources to which the PBCH with enhanced coverage is mapped can be further detected combining with a part of the sub-frame 5; and furthermore if resources to which the PBCH with enhanced coverage is mapped, are not detected correctly in the sub-frames 0 and 5, then resources to which the PBCH with enhanced coverage is mapped can be further detected in the sub-frame 1 and the sub-frame 6 until resources to which the PBCH with enhanced coverage is mapped, are detected correctly.

Those particular resources, in the respective sub-frames, to which the PBCH with enhanced coverage is mapped, can be specified in the specification to thereby ensure the network-side device to be consistent with the user equipment.

Since there are three symbols in the DwPTS, then there will be no additional symbols in which the PBCH with enhanced coverage can be transmitted, so the indices of the symbols in the DwPTS, to which the PBCH with enhanced coverage is mapped, are absent (that is, there are no additional symbols in which the PBCH with enhanced coverage is transmitted) in the special sub-frame with the above special sub-frame configuration, then the network-side device will not transmit the PBCH with enhanced coverage in the DwPTS even if the DwPTS is specified for transmission of the PBCH with enhanced coverage.

In the example above, the PBCH with enhanced coverage is carried in the reserved CSI-RS REs or symbols in the embodiment of the invention to thereby lower the probability that PBCH being retransmitted collide with CSI-RSs so as to achieve an advantage of good compatibility with a legacy UE.

Several examples of resources, in a radio frame, to which the PBCH with enhanced coverage can be mapped, will be listed below.

The embodiment of this method will be described below taking a normal Cyclic Prefix (CP) as an example, but the description of the normal CP will equally apply to an extended CP, so a repeated description thereof will be omitted here. For the sake of brevity and analogy, only the examples of transmitting PBCH in the sub-frames 0, 1, 5 and 6 will be listed below, but transmission of the PBCH with enhanced coverage in sub-frame 9 will not be exemplified.

In a first example, the PBCH with enhanced coverage is mapped onto other REs than REs where CRS ports 0 to 3 are located, in other symbols than symbols occupied by legacy PBCH, SSSs, and PDCCHs, in the sub-frames 0 and 5.

As illustrated in FIG. 2, the PBCH with enhanced coverage is mapped onto other REs than REs where CRS ports 0 to 3 are located, in 16 symbols including symbols 3, 4, 5 and 6 in a time slot 0, and symbols 4 and 5 in a time slot 1, in the sub-frame 0, and symbols 3, 4, 5 and 6 in a time slot 10, and symbols 0, 1, 2, 3, 4 and 5 in a time slot 11, in the sub-frame 5.

In a second example, PBCHs with enhanced coverage are mapped onto other REs than REs where CRS ports 0 to 3 are located, in other symbols than symbols occupied by legacy PBCH, PSSs, SSSs, and PDCCHs, in the sub-frames 0, 1, 5 and 6.

Since there are three symbols in the DwPTS, then there will be no addition symbols in which the PBCH with enhanced coverage is transmitted, so preferably this example can be applied to a special sub-frame configuration supporting six or more symbols in the DwPTS for a better effect.

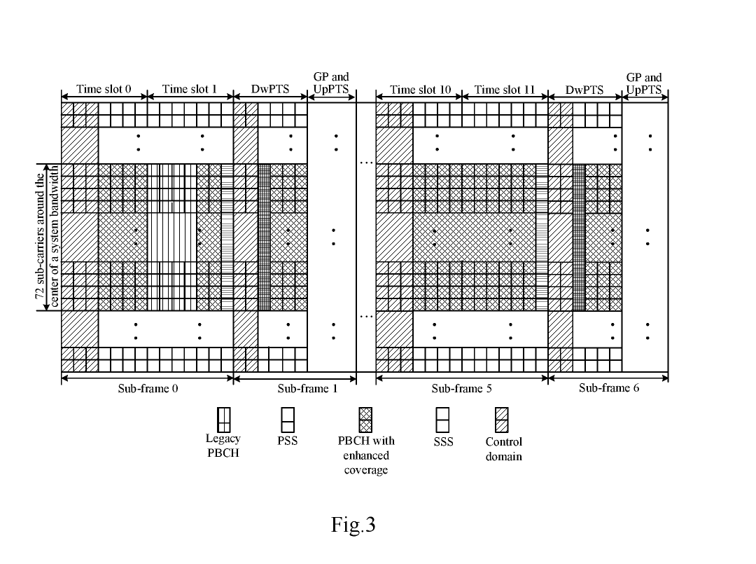

As illustrated in FIG. 3, in this example, the PBCH with enhanced coverage is mapped onto other REs than REs where CRS ports 0 to 3 are located, in 22 symbols including symbols 3, 4, 5 and 6 in a time slot 0, and symbols 4 and 5 in a time slot 1, in the sub-frame 0, symbols 3, 4 and 5 in the DwPTS in the sub-frame 1, symbols 3, 4, 5 and 6 in a time slot 10, and symbols 0, 1, 2, 3, 4 and 5 in a time slot 11, in the sub-frame 5, and symbols 3, 4 and 5 in the DwPTS in the sub-frame 6.

In an implementation, since there are three symbols in the DwPTS in the special sub-frame configurations 0 and 5, no PBCH will be mapped in the DwPTS in the sub-frame 1 and the sub-frame 6.

In a third example, the PBCH with enhanced coverage is mapped onto other REs than REs where CRS ports 0 to 3 and reserved CSI-RS ports are located, in other symbols than symbols occupied by legacy PBCH, SSSs, and PDCCHs, in the sub-frames 0 and 5.

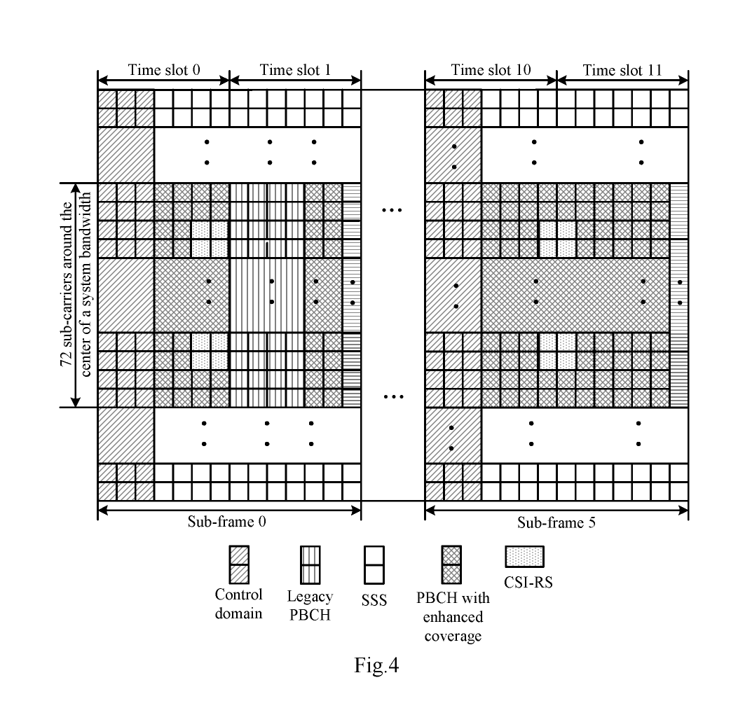

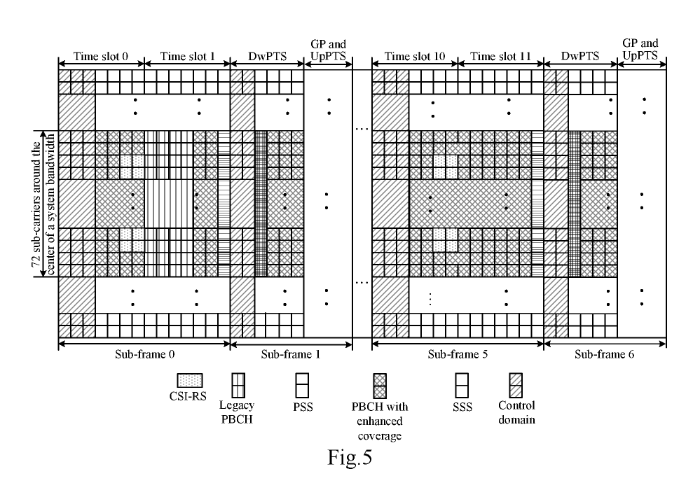

As illustrated in FIG. 4, the PBCH with enhanced coverage is mapped onto other REs than REs where CRS ports 0 to 3 and reserved CSI-RS ports are located, in 16 symbols including symbols 3, 4, 5 and 6 in a time slot 0, and symbols 4 and 5 in a time slot 1, in the sub-frame 0, and symbols 3, 4, 5 and 6 in a time slot 10, and symbols 0, 1, 2, 3, 4 and 5 in a time slot 11, in the sub-frame 5.

In a fourth example, the PBCH with enhanced coverage is mapped onto other REs than REs where CRS ports 0 to 3 and reserved CSI-RS ports are located, in other symbols than symbols occupied by legacy PBCH, PSSs, SSSs, and PDCCHs, in the sub-frames 0, 1, 5 and 6.

If there are three symbols in the DwPTS, then there will be no addition symbols in which the PBCH with enhanced coverage is transmitted, so preferably this example can be applied to a special sub-frame configuration supporting six or more symbols in the DwPTS for a better effect.

As illustrated in FIG. 3, in this example, the PBCH with enhanced coverage is mapped onto other REs than REs where CRS ports 0 to 3 and reserved CSI-RS ports are located, in 22 symbols including symbols 3, 4, 5 and 6 in a time slot 0, and symbols 4 and 5 in a time slot 1, in the sub-frame 0, symbols 3, 4 and 5 in the DwPTS in the sub-frame 1, symbols 3, 4, 5 and 6 in a time slot 10, and symbols 0, 1, 2, 3, 4 and 5 in a time slot 11, in the sub-frame 5, and symbols 3, 4 and 5 in the DwPTS in the sub-frame 6.

In an implementation, since there are three symbols in the DwPTS in the special sub-frame configurations 0 and 5, no PBCH will be mapped in the DwPTS in the sub-frame 1 and the sub-frame 6.

In a fifth example, the PBCH with enhanced coverage is mapped onto other REs than

REs where CRS ports are located, in other symbols where CRS ports are located than symbols occupied by legacy PBCH, and PDCCHs, in the sub-frames 0 and 5, and other REs than REs where CRS ports 0 to 3 are located, in a part or all of other symbols than symbols occupied by PSSs and PDCCHs, in the sub-frames 1 and 6.

If there are three symbols in the DwPTS, then there will be no addition symbols in which the PBCH with enhanced coverage is transmitted, so preferably this example can be applied to a special sub-frame configuration supporting six or more symbols in the DwPTS for a better effect.

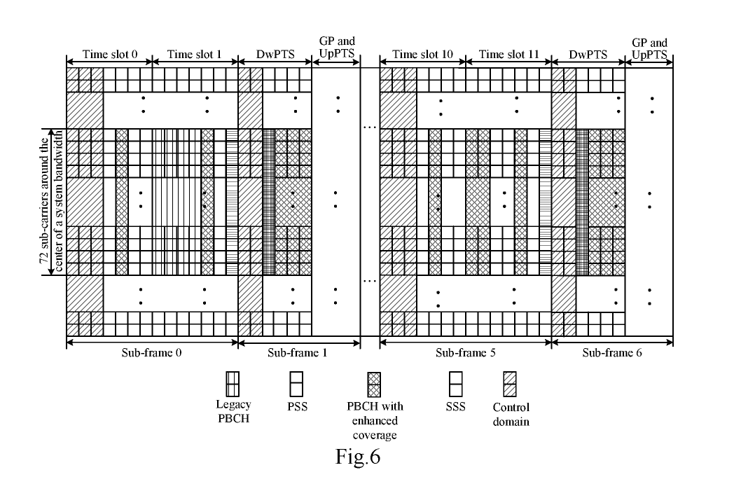

As illustrated in FIG. 6, the PBCH with enhanced coverage is mapped onto other REs than REs where CRS ports 0 to 3 are located, in 12 symbols including a symbol 4 in a time slot 0, and symbol 4 in a time slot 1, in the sub-frame 0, symbols 3, 4 and 5 in the DwPTS in the sub-frame 1, a symbol 4 in a time slot 10, and symbols 0, 1 and 4 in a time slot 11, in the sub-frame 5, and symbols 3, 4 and 5 in the DwPTS in the sub-frame 6.

In an implementation, since there are three symbols in the DwPTS in the special sub-frame configurations 0 and 5, no PBCH will be mapped in the DwPTS in the sub-frame 1 and the sub-frame 6.

In a sixth example, the PBCH with enhanced coverage is mapped onto other REs than REs where CRS ports are located, in other symbols than symbols occupied by legacy PBCH, PDCCHs, SSSs, and CSI-RSs, in the sub-frames 0 and 5, and other REs than REs where CRS ports 0 to 3 are located, in a part or all of other symbols than symbols occupied by PSSs and PDCCHs, in the sub-frames 1 and 6.

Since there are three symbols in the DwPTS, then there will be no addition symbols in which the PBCH with enhanced coverage is transmitted, so preferably this example can be applied to a special sub-frame configuration supporting six or more symbols in the DwPTS for a better effect.

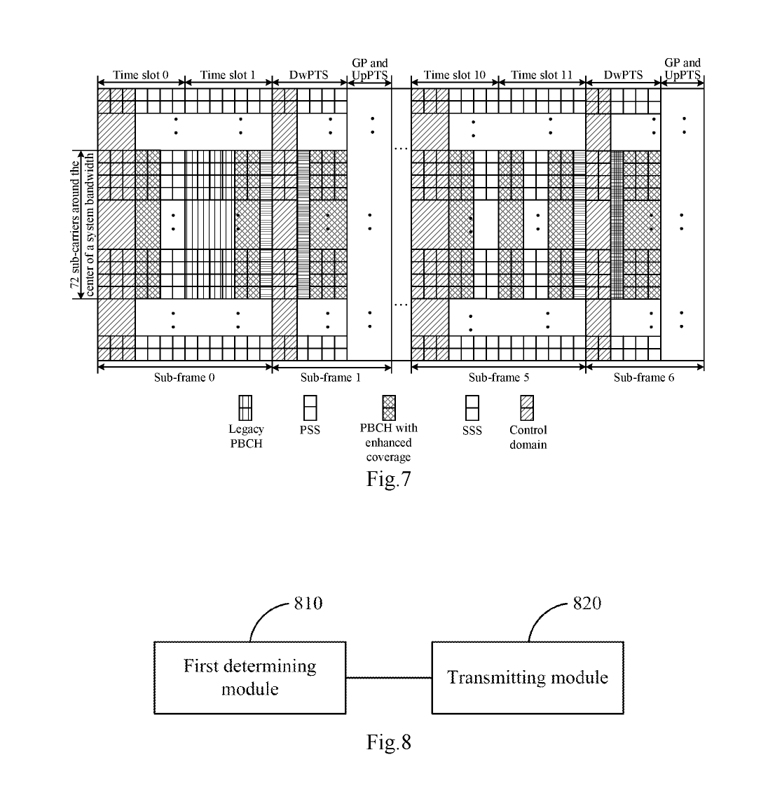

As illustrated in FIG. 7, the PBCH with enhanced coverage is mapped onto other REs than REs where CRS ports 0 to 3 are located, in 18 symbols including symbols 3 and 4 in a time slot 0, and symbols 4 and 5 in a time slot 1, in the sub-frame 0, symbols 3, 4 and 5 in the DwPTS in the sub-frame 1, symbols 3 and 4 in a time slot 10, and symbols 0, 1, 4 and 5 in a time slot 11, in the sub-frame 5, and symbols 3, 4 and 5 in the DwPTS in the sub-frame 6.

In an implementation, since there are three symbols in the DwPTS in the special sub-frame configurations 0 and 5, no PBCH will be mapped in the DwPTS in the sub-frame 1 and the sub-frame 6.

As illustrated in FIG. 8, a first network-side device in the system for transmitting a PBCH according to an embodiment of the invention includes:

A first determining module 810 is configured to determine resources, in at least one radio frame, to which a PBCH with enhanced coverage is mapped; and

A transmitting module 820 is configured to transmit the PBCH with enhanced coverage over the resources determined.

Preferably the first determining module 810 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs, and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the first determining module 810 is configured:

To determine the following resources in the at least one radio frame as the resources to which the PBCH with enhanced coverage is mapped:

A part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the first determining module 810 is configured:

To determine the following resources in the at least one radio frame as the resources to which the PBCH with enhanced coverage is mapped:

A part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the first determining module 810 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

As illustrated in FIG. 9, a first user equipment in the system for transmitting a PBCH according to an embodiment of the invention includes:

A second determining unit 910 is configured to determine resources, in at least one radio frame, to which a PBCH with enhanced coverage is mapped; and

A receiving module 920 is configured to receive the PBCH with enhanced coverage over the resources determined.

Preferably the second determining unit 910 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs, and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the second determining unit 910 is configured:

To determine the following resources in the at least one radio frame as the resources to which the PBCH with enhanced coverage is mapped:

A part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the second determining unit 910 is configured:

To determine the following resources in the at least one radio frame as the resources to which the PBCH with enhanced coverage is mapped:

A part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the second determining unit 910 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

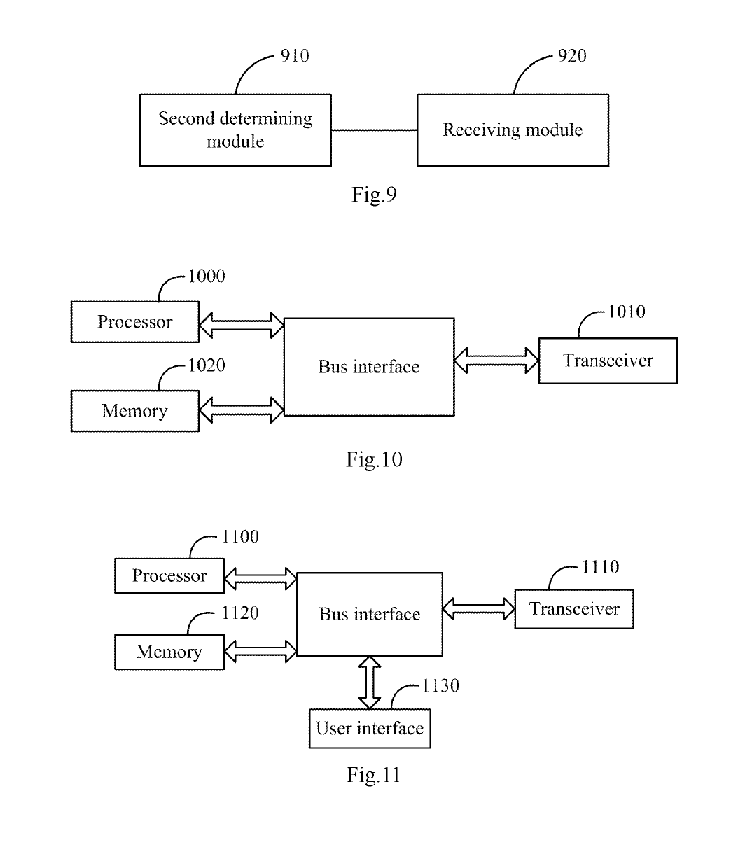

As illustrated in FIG. 10, a second network-side device in the system for transmitting a PBCH according to an embodiment of the invention includes:

A processor 1000 is configured to determine resources, in at least one radio frame, to which a PBCH with enhanced coverage are mapped, and to transmit the PBCH with enhanced coverage over the resources determined through a transceiver 1010; and

The transceiver 1010 is configured to be controlled by the processor 1000 to transmit and receive data.

Preferably the processor 1000 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs, and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the processor 1000 is configured:

To determine the following resources in the at least one radio frame as the resources to which the PBCH with enhanced coverage is mapped:

A part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the processor 1000 is configured:

To determine the following resources in the at least one radio frame as the resources to which the PBCH with enhanced coverage is mapped:

A part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the processor 1000 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

Here in Fg. 10, a bus architecture can include any number of interconnection buses and bridges which are particularly configured to link various circuits together including one or more processor represented by the processor 1000, and a memory represented by a memory 1020. The bus architecture can link various other circuits together, e.g., peripheral devices, a manostat, a power management circuit, etc., all of which are well known in the art, so a repeated description thereof will be omitted in this context. A bus interface provides an interface. The transceiver 1010 can include a plurality of elements including a transmitter and a receiver configured to provide elements communicating with other various apparatuses over a transmission medium. The processor 1000 is responsible for managing the bus architecture and common processes, and the memory 1020 can store data used by the processor 1000 in performing operations.

The processor 1000 is responsible for managing the bus architecture and common processes, and the memory 1020 can store data used by the processor 1000 in performing operations.

As illustrated in FIG. 11, a second user equipment in the system for transmitting a PBCH according to an embodiment of the invention includes:

A processor 1100 is configured to determine resources, in at least one radio frame, to which a PBCH with enhanced coverage is mapped, and to receive the PBCH with enhanced coverage over the resources determined through a transceiver 1110; and

The transceiver 1110 is configured to be controlled by the processor 1100 to transmit and receive data.

Preferably the processor 1100 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs, and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the processor 1100 is configured:

To determine the following resources in the at least one radio frame as the resources to which the PBCH with enhanced coverage is mapped:

A part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the processor 1100 is configured:

To determine the following resources in the at least one radio frame as the resources to which the PBCH with enhanced coverage is mapped:

A part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the processor 1100 is configured:

To determine the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

Here in Fg. 11, a bus architecture can include any number of interconnection buses and bridges which are particularly configured to link various circuits together including one or more processor represented by the processor 1100, and a memory represented by a memory 1120. The bus architecture can link various other circuits together, e.g., peripheral devices, a manostat, a power management circuit, etc., all of which are well known in the art, so a repeated description thereof will be omitted in this context. A bus interface provides an interface. The transceiver 1110 can include a plurality of elements including a transmitter and a receiver configured to provide elements communicating with other various apparatuses over a transmission medium. For different user equipment, a user interface 1130 can also be an interface via which needed internal and external devices can be connected, where the connected devices include but will not be limited to a keypad, a display, a speaker, a microphone, a joystick, etc.

The processor 1100 is responsible of managing the bus architecture and of common processes, and the memory 1120 can store data used by the processor 1100 in operation.

Based upon the same inventive idea, embodiments of the invention further provide a method for transmitting a PBCH by a network-side device, and a method for receiving a PBCH by a user equipment, and since these methods correspond to devices which are the devices in the system for transmitting a PBCH according to the embodiment of the invention, and address the problem under a similar principle to the system, reference can be made to the implementation of the system for implementations of these methods, so a repeated description thereof will be omitted here.

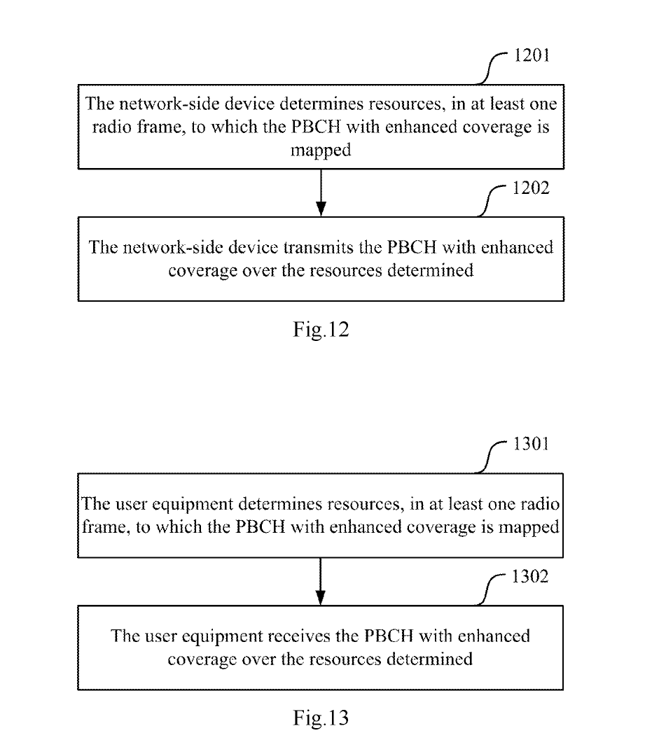

As illustrated in FIG. 12, a method for transmitting a PBCH by a network-side device according to an embodiment of the invention includes the following operations:

In the operation 1201, the network-side device determines resources, in at least one radio frame, to which a PBCH with enhanced coverage is mapped; and

In the operation 1202, the network-side device transmits the PBCH with enhanced coverage over the resources determined.

Preferably the network-side device determines the resources, in the at least one radio frame, to which the PBCH with enhanced coverage is mapped, as follows:

The network-side device determines the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs, and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the network-side device determines the resources, in the at least one radio frame, to which the PBCH with enhanced coverage is mapped, as follows:

The network-side device determines the following resources in the at least one radio frame as the resources to which the PBCH with enhanced coverage is mapped:

A part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the network-side device determines the resources, in the at least one radio frame, to which the PBCH with enhanced coverage is mapped, as follows:

The network-side device determines the following resources in the at least one radio frame as the resources to which the PBCH with enhanced coverage is mapped:

A part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the network-side device determines the resources, in the at least one radio frame, to which the PBCH with enhanced coverage is mapped, as follows:

The network-side device determines the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

Preferably N is 72.

As illustrated in FIG. 13, a method for receiving a PBCH by a user equipment according to an embodiment of the invention includes the following operations:

In the operation 1301, the user equipment determines resources, in at least one radio frame, to which a PBCH with enhanced coverage is mapped; and

In the operation 1302, the user equipment receives the PBCH with enhanced coverage over the resources determined.

Preferably the user equipment determines the resources, in the at least one radio frame, to which the PBCH with enhanced coverage is mapped, as follows:

The user equipment determines the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs, and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the user equipment determines the resources, in the at least one radio frame, to which the PBCH with enhanced coverage is mapped, as follows:

The user equipment determines the following resources in the at least one radio frame as the resources to which the PBCH with enhanced coverage is mapped:

A part or all of other REs than REs where reserved CSI-RSs are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the user equipment determines the resources, in the at least one radio frame, to which the PBCH with enhanced coverage is mapped, as follows:

The user equipment determines the following resources in the at least one radio frame as the resources to which the PBCH with enhanced coverage is mapped:

A part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the user equipment determines the resources, in the at least one radio frame, to which the PBCH with enhanced coverage is mapped, as follows:

The user equipment determines the following resources in the at least one radio frame as the resources to which the PBCH with enhanced coverage is mapped:

A part or all of other REs than REs where CRS ports 0 to 3 are located, in a part or all of other symbols than symbols occupied by legacy PBCH, SSSs, and CSI-RSs, in a part or all of sub-frame 0, sub-frame 5, and sub-frame 9; and/or

A part or all of other REs than REs where CRS ports 0 to 3 are located, in a part or all of other symbols than symbols occupied by PSSs and PDCCHs, in a DwPTS of sub-frame 1; and/or

A part or all of other REs than REs where CRS ports 0 to 3 are located, in specific symbols of sub-frame 6;

Here the specific symbols are symbols in the sub-frame 6, indices of which are the same as indices of the symbols in which the PBCH with enhanced coverage is transmitted, in the DwPTS of the sub-frame 1.

Preferably the resources, in the at least one radio frame, to which the PBCH with enhanced coverage is mapped, are located on N sub-carriers around the center of a system bandwidth of the radio frame, where N represents a positive integer.

Preferably N is 72.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for transmitting a Physical Broadcast Channel (PBCH), the method comprising:
determining, by a network-side device, resources, in at least one radio frame, to which a PBCH with enhanced coverage is mapped; and
transmitting, by the network-side device, the PBCH with enhanced coverage over the resources determined.

2. The method according to claim 1, wherein determining, by the network-side device, the resources, in the at least one radio frame, to which the PBCH with enhanced coverage is mapped comprises:
determining, by the network-side device, the following resources in the at least one radio frame as the resources to which the PBCH with enhanced coverage is mapped:
a part or all of other Resource Elements (REs) than REs where Cell-specific Reference Signal (CRS) ports 0 to 3 are located, in a part or all of other symbols than symbols occupied by legacy PBCH, Secondary Synchronization Signals (SSSs), and Physical Downlink Control Channels (PDCCHs), in a part or all of sub-frame 0, sub-frame 5, and sub-frame 9; and/or
a part or all of other REs than REs where CRS ports 0 to 3 are located, in a part or all of other symbols than symbols occupied by Primary Synchronization Signals (PSSs), and PDCCHs, in a Downlink Pilot Time Slot (DwPTS) of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

3. The method according to claim 1, wherein determining, by the network-side device, the resources, in the at least one radio frame, to which the PBCH with enhanced coverage is mapped comprises:
determining, by the network-side device, the following resources in the at least one radio frame as the resources to which the PBCH with enhanced coverage is mapped:
a part or all of other REs than REs where reserved Channel State Information-Reference Signals (CSI-RSs) are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

4. The method according to claim 1, wherein determining, by the network-side device, the resources, in the at least one radio frame, to which the PBCH with enhanced coverage is mapped comprises:
determining, by the network-side device, the following resources in the at least one radio frame as the resources to which the PBCH with enhanced coverage is mapped:
a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

5. (canceled)

6. The method according to claim 1, wherein the resources, in the at least one radio frame, to which the PBCH with enhanced coverage is mapped, are located on N sub-carriers around the center of the system bandwidth of the radio frame, where N represents a positive integer; wherein N is 72.

7. (canceled)

8. A method for receiving a Physical Broadcast Channel (PBCH), the method comprising:
determining, by a user equipment, resources, in at least one radio frame, to which a PBCH with enhanced coverage is mapped; and
receiving, by the user equipment, the PBCH with enhanced coverage over the resources determined.

9. The method according to claim 8, wherein determining, by the user equipment, the resources, in the at least one radio frame, to which the PBCH with enhanced coverage is mapped comprises:
determining, by the user equipment, the following resources in the at least one radio frame as the resources to which the PBCH with enhanced coverage is mapped:
a part or all of other Resource Elements (REs) than REs where Cell-specific Reference Signal (CRS) ports 0 to 3 are located, in a part or all of other symbols than symbols occupied by legacy PBCH, Secondary Synchronization Signals (SSSs), and Physical Downlink Control Channels (PDCCHs), in a part or all of sub-frame 0, sub-frame 5, and sub-frame 9; and/or
a part or all of other REs than REs where CRS ports 0 to 3 are located, in a part or all of other symbols than symbols occupied by Primary Synchronization Signals (PSSs), and PDCCHs, in a Downlink Pilot Time Slot (DwPTS) of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

10. The method according to claim 8, wherein determining, by the user equipment, the resources, in the at least one radio frame, to which the PBCH with enhanced coverage is mapped comprises:
determining, by the user equipment, the following resources in the at least one radio frame as the resources to which the PBCH with enhanced coverage is mapped:
a part or all of other REs than REs where reserved Channel State Information-Reference Signals (CSI-RSs) are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

11. The method according to claim 8, wherein determining, by the user equipment, the resources, in the at least one radio frame, to which the PBCH with enhanced coverage is mapped comprises:
determining, by the user equipment, the following resources in the at least one radio frame as the resources to which the PBCH with enhanced coverage is mapped:
a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

12. (canceled)

13. The method according to claim 8, wherein the resources, in the at least one radio frame, to which the PBCH with enhanced coverage is mapped, are located on N sub-carriers around the center of a system bandwidth of the radio frame, where N represents a positive integer; wherein N is 72.

14. (canceled)

15. A network-side device for transmitting a Physical Broadcast Channel (PBCH), the network-side device comprising:
a processor configured to determine, resources, in at least one radio frame, to which a PBCH with enhanced coverage is mapped, and
to transmit the PBCH with enhanced coverage over the resources determined through a transceiver; and
the transceiver configured to be controlled by the processor to transmit and receive data.

16. The network-side device according to claim 15, wherein the processor is configured:
to determine the following resources in the at least one radio frame as the resources to which the PBCH with enhanced coverage is mapped:
a part or all of other Resource Elements (REs) than REs where Cell-specific Reference Signal (CRS) ports 0 to 3 are located, in a part or all of other symbols than symbols occupied by legacy PBCH, Secondary Synchronization Signals (SSSs), and Physical Downlink Control Channels (PDCCHs), in a part or all of sub-frame 0, sub-frame 5, and sub-frame 9; and/or
a part or all of other REs than REs where CRS ports 0 to 3 are located, in a part or all of other symbols than symbols occupied by Primary Synchronization Signals (PSSs), and PDCCHs, in a Downlink Pilot Time Slot (DwPTS) of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

17. The network-side device according to claim 15, wherein the processor is configured:
to determine the following resources in the at least one radio frame as the resources to which the PBCH with enhanced coverage is mapped:
a part or all of other REs than REs where reserved Channel State Information-Reference Signals (CSI-RSs) are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

18. The network-side device according to claim 15, wherein the processor is configured:
to determine the following resources in the at least one radio frame as the resources to which the PBCH with enhanced coverage is mapped:
a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

19. (canceled)

20. The network-side device according to claim 15, wherein the resources, in the at least one radio frame, to which the PBCH with enhanced coverage is mapped, are located on N sub-carriers around the center of a system bandwidth of the radio frame, where N represents a positive integer.

21. A user equipment for receiving a Physical Broadcast Channel (PBCH), the user equipment comprising:
a processor configured to determine resources, in at least one radio frame, to which a PBCH with enhanced coverage is mapped, and
to receive the PBCH with enhanced coverage over the resources determined through a transceiver; and
the transceiver configured to be controlled by the processor to transmit and receive data.

22. The user equipment according to claim 21, wherein the processor is configured:
to determine the following resources in the at least one radio frame as the resources to which the PBCH with enhanced coverage is mapped:
a part or all of other Resource Elements (REs) than REs where Cell-specific Reference Signal (CRS) ports 0 to 3 are located, in a part or all of other symbols than symbols occupied by legacy PBCH, Secondary Synchronization Signals (SSSs), and Physical Downlink Control Channels (PDCCHs), in a part or all of sub-frame 0, sub-frame 5, and sub-frame 9; and/or
a part or all of other REs than REs where CRS ports 0 to 3 are located, in a part or all of other symbols than symbols occupied by Primary Synchronization Signals (PSSs), and PDCCHs, in a Downlink Pilot Time Slot (DwPTS) of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

23. The user equipment according to claim 21, wherein the processor is configured:
to determine the following resources in the at least one radio frame as the resources to which the PBCH with enhanced coverage is mapped:
a part or all of other REs than REs where reserved Channel State Information-Reference Signals (CSI-RSs) are located, and REs where CRS ports 0 to 3 are located, in a part or all of other symbols than symbols occupied by legacy PBCH, SSSs, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

24. The user equipment according to claim 21, wherein the processor is configured:
to determine the following resources in the at least one radio frame as the resources to which the PBCH with enhanced coverage is mapped:
a part or all of other REs than REs where CRS ports 0 to 3 are located, in a part or all of symbols where CRS ports are located, in a part or all of other symbols than symbols occupied by legacy PBCH, and PDCCHs, in a part or all of sub-frame 0, sub-frame 5, and sub-frame 9; and/or
a part or all of other REs than REs where CRS ports 0 to 3 are located, in a part or all of other symbols than symbols occupied by PSSs and PDCCHs, in a DwPTS of sub-frame 1; and/or
a part or all of other REs than REs where CRS ports 0 to 3 are located, in specific symbols of sub-frame 6;
wherein the specific symbols are symbols in the sub-frame 6, indices of which are the same as indices of the symbols in which the PBCH with enhanced coverage is transmitted, in the DwPTS of the sub-frame 1.

25. (canceled)

26. The user equipment according to claim 21, wherein the resources, in the at least one radio frame, to which the PBCH with enhanced coverage is mapped, are located on N sub-carriers around the center of a system bandwidth of the radio frame, where N represents a positive integer.

27. (canceled)
